(19) United States
(12) Patent Application Publication
(10) Pub. No.: US 2009/0036805 A1
(43) Pub. Date: Feb. 5, 2009

(54) Method and Apparatus for Providing an Animal Vocalization Driven Massage Device

(75) Inventor: Elizabeth Muggenthaler, Hillsborough, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Purrfect Device Inc.

(21) Appl. No.: 11/833,317

(22) Filed: Aug. 3, 2007

(51) Int. Cl. A61H 1/00

(52) U.S. Cl. 601/47

(57) ABSTRACT

An apparatus for providing an animal vocalization driven massage device may include a memory device, a sound production device and a processing element. The memory device may store a pre-recorded animal vocalization. The sound production device may include an actuator in operational communication with a substrate and may be configured to enable communication of an output of the sound production device to living tissue. The processing element may be in communication with both the memory device and the sound production device. The processing element may be configured to drive the sound production device based on the pre-recorded animal vocalization.

### TECHNOLOGICAL FIELD

Embodiments of the present invention relate generally to therapeutic devices and, more particularly, relate to a method and apparatus for providing an animal vocalization to drive a massage device.

### BACKGROUND

Numerous devices have been developed to provide vibration, sound, magnetic field or electric stimulation to living tissue for the purposes of comfort, massage and/or enhanced healing. Frequencies applied and the corresponding power levels used by such devices often determine what type of benefit may be supplied and what tissue may receive benefits from the devices. For example, 50 Hz has been shown to be a beneficial frequency for bone stimulation or healing, 100 Hz has been shown to be beneficial for pain relief and 120 Hz has been shown to be a beneficial frequency for tendon healing. However, many such devices have been sold based on clever marketing ploys rather than based upon the actual benefits they may provide. As such, many devices have been produced that provide little to no actual benefit to the user and some devices may even harm the user depending upon the frequencies used and the power at which the frequencies are applied.

Additionally, the devices described above are often inflexible in their design insofar as they may have large and/or unwieldy constructions. Moreover, conventional massage or therapeutic devices may be useful for only limited applications rather than being adaptable to use in many different body locations or even with different animals.

Accordingly, it may be desirable to provide a device capable of overcoming at least some of the disadvantages discussed above.

### BRIEF SUMMARY

A method and apparatus are therefore provided that enable a user to apply sound to living tissue at healing frequencies and powers. In particular, a method and apparatus are provided that enable a user to provide a pre-recorded animal vocalization to drive a sound production device. In this regard, certain animal vocalizations have been shown to contain healing and/or therapeutic frequencies. However, in light of the fact that some of the healing frequencies are not audible to the human ear, synthetic reproductions of animal sounds may lack the ability to provide the same benefits that may be provided by playing a recording of an actual animal vocalization, since synthetic reproductions may not include all of the frequencies of the actual animal vocalization. Accordingly, embodiments of the present invention provide a mechanism by which to provide actual animal vocalizations to drive a sound production device. Moreover, embodiments of the present invention further provide a device that is compact and easy to use or apply in various different environments and with various different objects and/or living tissues.

In one exemplary embodiment, a method of providing an animal vocalization driven massage device is provided. The method may include accessing a pre-recorded animal vocalization, driving a sound production device comprising an actuator in operational communication with a substrate based on the pre-recorded animal vocalization, and communicating an output of the sound production device to living tissue.

In another exemplary embodiment, an apparatus for providing an animal vocalization driven massage device is provided. The apparatus may include a memory device, a sound production device and a processing element. The memory device may store a pre-recorded animal vocalization. The sound production device may include an actuator in operational communication with a substrate and may be configured to enable communication of an output of the sound production device to living tissue. The processing element may be in communication with both the memory device and the sound production device. The processing element may be configured to drive the sound production device based on the pre-recorded animal vocalization.

In another exemplary embodiment, an apparatus for providing an animal vocalization driven massage device is provided. The apparatus may include a memory device, a sound production device and a processing element. The memory device may store a pre-recorded animal vocalization. The sound production device may be configured to enable communication of an output of the sound production device to living tissue at about 32 dB to about 65 dB on contact with the living tissue. The processing element may be in communication with both the memory device and the sound production device. The processing element may be configured to drive the sound production device based on the pre-recorded animal vocalization.

Embodiments of the invention may provide a method and apparatus for driving a sound device using a pre-recorded animal vocalization. As a result, for example, a massage device may be provided that may provide sound, including infrasound (i.e., sound that is of too low a frequency to be detected by the human ear), that may include frequencies capable of providing comfort and/or healing.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a device capable of reproducing an animal vocalization according to an exemplary embodiment of the present invention;

FIG. 2 is an illustration of one example of a device capable of reproducing an animal vocalization according to an exemplary embodiment of the present invention;

FIG. 3 is an illustration of an exemplary device capable of reproducing an animal vocalization for the treatment of a horse according to an exemplary embodiment of the present invention;

FIG. 4 is an illustration of an exemplary device capable of reproducing an animal vocalization for the treatment of a human knee according to an exemplary embodiment of the present invention; and

FIG. 5 is a block diagram according to an exemplary method for providing an animal vocalization driven massage device according to an exemplary embodiment of the present invention.

### DETAILED DESCRIPTION

Scientists have studied animal vocalization to try to determine the purposes of the sounds various animals make. Though some animal vocalization may be linked to forms of communication, like mating calls, distress calls, etc., research in the field of animal vocalizations has indicated that some animal vocalizations may have purposes (or at least potential uses) beyond merely communicating. In this regard, for example, it has been noted that cats such as the common household cat and other felids purr at relatively similar frequencies. Moreover, the frequencies at which many felids purr include a fundamental frequency at about 25 Hz and substantial harmonics at or near 50 Hz and 120 Hz, which coincide with beneficial healing frequencies described above. Thus, although it has long been speculated that felids purr as a comfort or relaxation mechanism, felids may actually purr to heal themselves.

Cats and many pets in general can have a calming effect on people. In this regard, petting a purring cat may relax and/or comfort an individual. Similar results may be provided to not only humans, but other animals as well. Thus, the application of a felid purr via a massage device may not only provide a relaxing and/or comforting effect to the subject receiving the application, but the subject may also receive healing or other health benefits. For example, horses and other animals that are transported long distances in a standing, but otherwise sedentary posture, may develop bone, muscle or tendon problems. Particularly for racing or other performing horses, for whom transportation to various events are necessary and for whom activity is commenced upon reaching the destination, the transportation mode may create increased, yet unavoidable risks. Accordingly, leg wraps or braces are commonly used during injury to the tendons and for strength during participation in events. Although certain leg braces have been developed to assist in preventing problems associated with transporting such animals, such braces could be improved by adding a capability to treat the animal's legs with an animal vocalization such as a felid purr. Accordingly, by recording the felid purr and applying the felid purr to the leg brace, other objects that vibrate or otherwise transmit signals at the frequencies of a felid purr that may contact living tissue, or even directly to the tissue itself, a massage device may be provided that can provide comfort, relaxation and/or healing. In addition, for example, Heaves, or Chronic Obstructive Pulmonary Disease (C.O.P.D) are ailments that occur in horses and are currently incurable. Thus, since the frequencies present in the cat's purr and in other animal vocalizations are the same frequencies that may be used for the relief of C.O.P.D in humans, the benefits may extend to horses as well.

Although a felid purr has been described above, it should be noted that other animal species also produce animal vocalizations that may be useful in this regard. For example, the Sumatran rhino, dolphins, whales, giraffes and other animals also produce animal vocalizations that may include frequencies that are beneficial to humans or living tissue in other animals. In this regard, the benefits may be related to healing, relaxation, comfort, or merely enjoyment. However, typical recordings of animal vocalizations are not captured or played back with any concern for frequencies that are too high or low for the human ear to appreciate. This is because such animal vocalizations are typically recorded for sound effects to associate with models, toys or games and not for utilitarian purposes. Thus, since nature has apparently equipped animals such as the cat to produce numerous beneficial frequencies at beneficial levels, and since other animal vocalizations may also include frequencies that are not normally captured by typical recording devices, it may be desirable to record even some of the inaudible frequencies of animal vocalizations for playback. As such, it may be most desirable to utilize the natural sounds themselves rather than attempting to duplicate the sounds with synthetic reproduction techniques.

Unfortunately, given that some of the animal vocalizations that may be desired for use in embodiments of the present invention include frequencies near or below the range of human hearing, it has largely been impractical to produce a device capable of accurately reproducing the animal vocalizations. In this regard, production of low frequency sounds has typically required large speakers that would not be practical for use in a mobile device or a device to be used with animals. However, mechanisms may now exist that will enable the accurate reproduction of animal vocalizations within the ranges desired. In particular, an actuator such as, for example, a 55 mm actuator produced by Panasonic, may have sufficient frequency response to provide an accurate animal vocalization reproduction in a relatively small package that may be adaptable to several different applications. Additionally, typical recording techniques do not account for or accurately record the lower and possibly inaudible frequencies, since they are not easily perceptible by humans. Thus, by using special microphones and/or accelerometers to record animal vocalizations, previously ignored (and in some cases inaudible) frequencies may be captured which, if rendered accurately by a sound production device in communication with living tissue, may provide the unexpected result of providing healing and/or therapeutic frequencies to the living tissue.

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

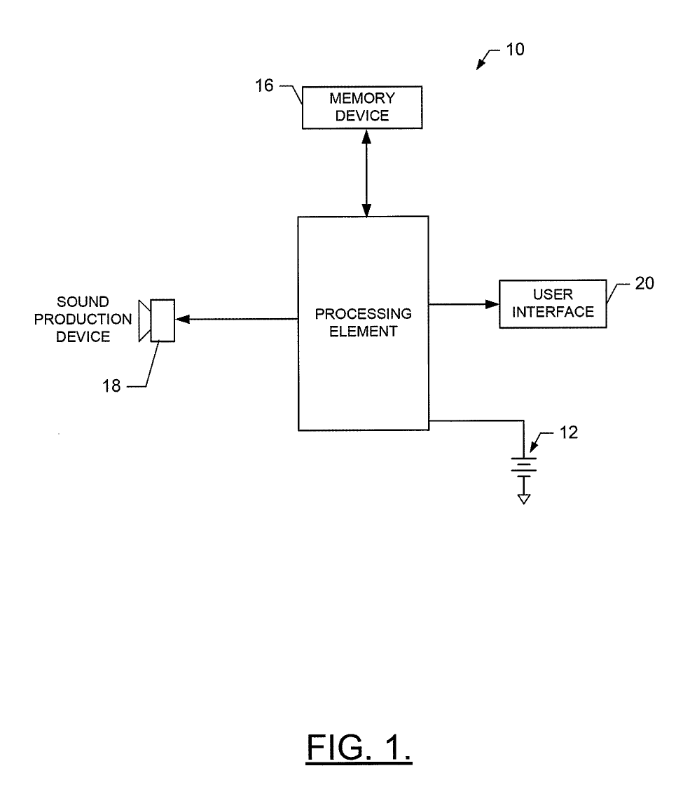

FIG. 1 is a schematic block diagram of a device capable of reproducing an animal vocalization for massage purposes according to an exemplary embodiment of the present invention. It should be understood, however, that a device as illustrated and hereinafter described is merely illustrative of one type of device that would benefit from embodiments of the present invention and, therefore, should not be taken to limit the scope of embodiments of the present invention. While one embodiment of a device 10 that is mobile is illustrated and will be hereinafter described for purposes of example, other types of devices can readily employ embodiments of the present invention. In this regard, devices that are fixed or otherwise not easily moved from one location to another may also readily employ embodiments of the present invention. As such, the apparatus and method of exemplary embodiments of the present invention will be primarily described below in conjunction with a mobile, e.g., direct current (DC) or battery powered, application. However, it should be understood that the apparatus and method of embodiments of the present invention can also or alternatively be utilized in conjunction with a variety of other applications, such as chorded applications powered directly by household alternating current (AC) or other power sources.

The device 10 according to one exemplary embodiment may include a battery 12 (or multiple batteries), a processing element 14, a memory device 16 and a sound production device 18. It should be understood that the processing element 14 may include circuitry desirable for implementing audio and logic functions of the device 10. For example, the processing element 14 may be comprised of a digital signal processor device, a microprocessor device, and various analog to digital converters, digital to analog converters, amplifiers, oscillators and other support circuits. Control and signal processing functions of the device 10 may be allocated between these devices according to their respective capabilities. The processing element 14 may also include the functionality to record audio data (e.g., an animal vocalization) in the memory device 16 such as, for example, via an internal voice recorder. Additionally or alternatively, the processing element 14 may include functionality to operate one or more software programs, which may be stored in the memory device 16. The software program(s) may store instructions which, when executed provide for the rendering of animal vocalization via the sound production device 18. Additionally or alternatively, the software program(s) may store instructions for different programming with respect to the rendering of certain ones among a plurality of stored animal vocalizations.

The processing element 14 may be embodied in a number of different ways. For example, the processing element 14 may be embodied as a processor, a coprocessor, a controller or various other processing means or devices including integrated circuits such as, for example, an ASIC (application specific integrated circuit). In an exemplary embodiment, the processing element 14 may be configured to execute instructions stored in the memory device 16 or otherwise accessible to the processing element 14. Alternatively, the processing element 14 may be embodied as any device or means embodied in either hardware, software, or a combination of hardware and software that is configured to record and/or render data stored in the memory device 16 from/to the sound production device 18.

The memory device 16 may include volatile memory, such as volatile Random Access Memory (RAM) including a cache area for the temporary storage of data and/or non-volatile memory, which can be embedded and/or may be removable. The non-volatile memory may additionally or alternatively comprise an EEPROM, flash memory or the like. The memory device 16 may store any of a number of pieces of information, and data, used by the device 10 to implement the functions of the device 10. In an exemplary embodiment, the memory device 16 may store digital or analog audio data including one or more animal vocalizations.

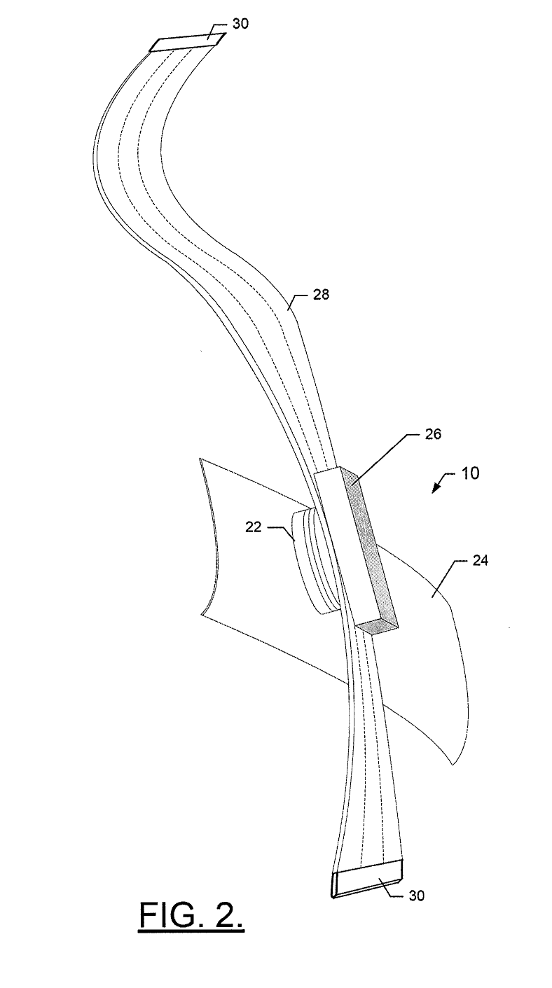

The sound production device 18 may be embodied in many ways. For example, the sound production device 18 may include a conventional earphone or speaker and/or a microphone. However, it should be noted that not all sounds produced by the sound production device 18 may be audible to the human ear. In an exemplary embodiment, the sound production device 18 may include an actuator 22 in operational communication with a substrate 24 (see FIG. 2). In this regard, the actuator 22, when placed in contact with the substrate 24, may cause the substrate 24 to vibrate in accordance with audio data being used by the processing element 14 to drive the sound production device 18. The vibration of the substrate 24 at frequencies determined by the audio data may correspondingly move air at a sound pressure level determined by (and/or proportional to) a power level of the signal corresponding to the audio data that is used to drive the sound production device 18. In general, the actuator 22 may be any device that is configured to produce mechanical motion by converting various forms of energy (e.g., signals of the audio data recording an animal vocalization) to rotating or linear mechanical energy. However, an actuator according to embodiments of the present invention, in order to effectively communicate beneficial animal vocalization frequencies, may have a frequency response of about 25 Hz to about 120 Hz at about 32 dB to about 65 dB on contact. Accordingly, an actuator according to embodiments of the present invention may be capable of delivering sound and/or vibration to an object or tissue at sufficient sound pressure levels to provide a benefit (e.g., 32-65 dB), but not of excessive power levels that may actually do harm.

In an exemplary embodiment, as shown in FIG. 2, the actuator 22 may be placed in operational communication with the substrate 24 by any suitable mechanism. For example, an adhesive may be applied to portions of a casing of the actuator 22 to adhere the actuator 22 to the substrate 24. Alternatively, pressure may be applied to hold the actuator 22 in contact with the substrate 24. The substrate 24 may then be placed and/or held in contact with an object or body part in order to communicate sound produced by the actuator 22 of the sound production device 18 to the object or body part at frequencies that include animal vocalization from about 25 Hz to about 120 Hz at about 32 dB to about 65 dB on contact. In an exemplary embodiment, a remainder of the device 10 (other than the actuator 22 and the substrate 24 (if applicable) may be disposed in a casing 26 which may be in operable communication with the actuator 22. The casing 26 may be a rigid frame for enclosing, for example, the processing element 14 and the memory device 16. In an exemplary embodiment, the casing 26 may be made of plastic or another waterproof and rigid material. The casing 26 and/or portions of the actuator 22 may be wrapped in padding, cloth and/or other materials in order to make the device 10 more comfortable to wear. However, such wrapping may also be for ornamentation purposes, with designs, pictures, etc. being displayed on the wrapping. Alternatively, the casing 26 itself may include such ornamentation.

In one exemplary embodiment, the casing 26 could serve as the substrate 24. In this regard, for example, the material of the casing 26 could be vibrated in accordance with the signal used to drive the actuator 22. As such, for example, the actuator 22 itself could be within the casing 26 thereby enabling the entirety of the device 10 to be embodied within the casing 26.

As shown in the example of FIG. 2, the actuator 22 may be in communication with an attachment strap 28, which may also be in communication with the casing 26. The attachment strap 28 may be made of any suitable material. Suitability of materials used for the attachment strap 28 may depend on the particular application intended for the device 10. For example, a stretchable (e.g., elastic) material may be preferred for comfort in human applications or for animals with particular sensitivities. However, leather or strong fibers may be preferred for some animal applications involving relatively large animals. Materials such as nylon, rubber, neoprene, vinyl polymers, waterproof or semi-waterproof breathable fabrics and so on may be desirable for employment in materials comprising the attachment strap 28 for use in environments where the device 10 is expected to get wet or dirty repeatedly. Coverings for the attachment strap 28 may also be provided for comfort, ornamentation or durability purposes.

In an exemplary embodiment, the casing 26 and/or the actuator 22 may be attached to the attachment strap 28 via a fastener such as, for example, a buckle, a snap, a zipper, a hook and loop fastener (e.g., Velcro), a temporary adhesive, or another bonding mechanism such as, for example, a medical adhesive, or by the use of a medical adhesive knit such as the knit produced by Spenco. The attachment strap 28 may then be wrapped around an object or body part and ends of the attachment strap 28 may be secured to one another using a fastener 30 such as, for example, any of the fasteners described above or another suitable fastener. The attachment strap 28 could alternatively be embodied as a continuous elastic band that may stretch over a particular body part or object.

Different lengths and/or compositions of the attachment strap 28 may be provided for different uses. For example, a large strap could be provided for employment on a chest cavity of a large animal, while a small strap could be provided for employment with smaller animals or for use with smaller appendages. In some embodiments, the attachment strap 28 could be adjustable in length. In an exemplary embodiment, multiple casings 26 and/or actuators 22 may be provided for use with a larger strap.

Some exemplary embodiments may not include the attachment strap 28 and thus, the device 10 may be placed into contact with a body part or object without wrapping around the object, such as by fixing the device directly to the body part or object. A fastener or gravity may be used to maintain contact between the device 10 and the body part or object. However, contact between the device 10 and the body part or object may also be maintained by the application of manual force, such as holding the device 10 in one's hand to apply the device 10 to a particular object or body part. In this regard, the actuator 22 itself may be placed in contact with the object or body part, or the substrate 24 may be placed in contact with the object or body part.

The substrate 24 may be any substance which, when placed in contact with the actuator 22 may vibrate at frequencies corresponding to (or matching the frequencies of) the audio data driving the actuator 22 sufficient to produce about 32 dB to about 65 dB on contact. In an exemplary embodiment, the substrate 24 may be a metal, wood, plastic, or composite material (e.g., a plastic/bamboo composite) that may be chosen based on its properties with respect to communication of sound producing vibrations. Some embodiments may benefit from a relatively lightweight substrate and/or a relatively ductile or flexible substrate. Accordingly, the substrate 24 may, in some embodiments, be moldable to the object or body part with which the substrate 24 is placed into contact. Examples of materials that may be used as the substrate include, but are not limited to, synthetic fibers, polyester fibers, plastics, mylar, Kevlar, bamboo, aluminum, composite materials, combinations of the above listed materials, and/or other suitable materials.

As indicated above, the actuator 22 may be placed in contact with the skin, coat, fur, bone, or hide of an animal or person. Accordingly, under such circumstances the skin, coat, fur, bone, or hide of the animal or person may function as the substrate 24. Thus, the actuator 22 may cause the skin, coat, fur, bone, or hide of the animal or person to vibrate and produce sound at the frequencies and power levels described above. In some embodiments, the presence of clothing or even a thin cloth or fabric covering over the actuator 22 may not interfere with the ability of the actuator 22 to produce frequencies in the ranges and powers employed according to embodiments of the present invention.

As yet another alternative, the actuator 22 may be placed in direct contact with many other types of devices, articles and/or apparatuses and the corresponding devices, articles and/or apparatuses may act as the substrate 24. For example, the actuator 22 may be placed in contact with a commercial leg brace such as the type of leg brace that is commonly used for transportation of horses. As such, the leg brace (e.g., the foam padding of the leg brace) may act as the substrate. Alternatively, the actuator 22 (and/or the substrate 24) may be placed into contact with a cast, wound dressing, a knee or ankle brace, a bed, a blanket, a crib, a kennel floor, ceiling or walls, or numerous other objects that may communicate sound to an animal or person. Accordingly, the actuator 22 may drive the substrate 24 (or the body part, article, device or apparatus functioning as the substrate) to vibrate and/or produce sound based on the audio data (i.e., the recorded animal vocalization) used to drive the sound production device 18. Thus, embodiments of the present invention need not be manufactured as an additional feature included in other articles (although such manufacturing is possible) that are produced. Rather, embodiments of the present invention may be provided in a simple form that is adaptable to use with many other articles by attachment to or contact with the other articles.

In an exemplary embodiment, the device 10 may include a user interface 20 that is in communication with the processing element 14. The user interface 20 may include any of a number of devices allowing the device 10 to receive data and/or mode selection inputs. In this regard, the user interface 20 may include a keypad or other input device. The keypad may include one or more keys with associated functions. In an exemplary embodiment, a function key of the user interface 20 may be used to make a mode selection (e.g., selecting a particular animal vocalization from among a plurality of different stored animal vocalizations) or a program selection (e.g., a runtime for the device 10 such as, for example, 2 minutes, 90 minutes, etc., or a program including numerous different vocalizations for prescribed times). In one embodiment, the user interface 20 may simply be an on/off switch for powering the device 10 on or off. The user interface 20 may also enable the user to record further animal vocalizations for employment in connection with the device 10. In this regard, for example, the user interface 20 could include a microphone for recording audio data.

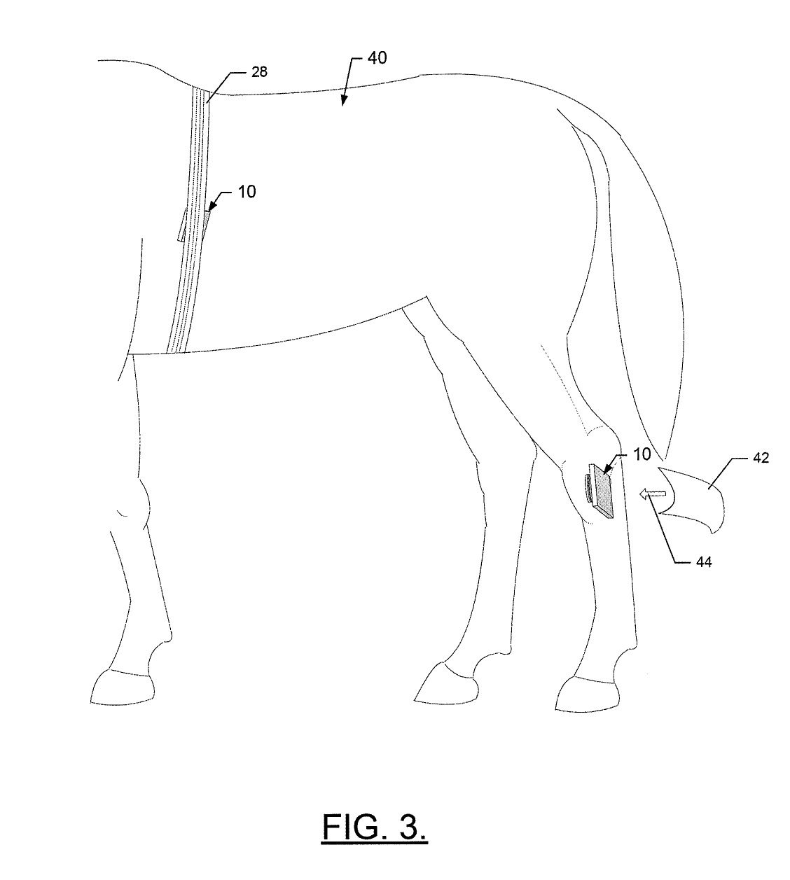

FIG. 3 is an illustration of an exemplary device capable of reproducing an animal vocalization for the treatment of a horse according to an exemplary embodiment of the present invention. In this regard, FIG. 3 illustrates a horse 40 having one embodiment of the device 10 attached to a chest region of the horse 40, for example, for the treatment of COPD and another embodiment of the device 10 attached to hock or back knee of the horse 40. As can be seen from FIG. 3, a medical adhesive knit or patch 42 may be applied to the device as indicated by the arrow 44 in order to cover the device 10 and secure the device 10 to the horse 40. As an alternative, an attachment strap 28 may be used to secure the device 10 to the chest of the horse 40. Other mechanisms for securing devices and other uses for the devices are also possible.

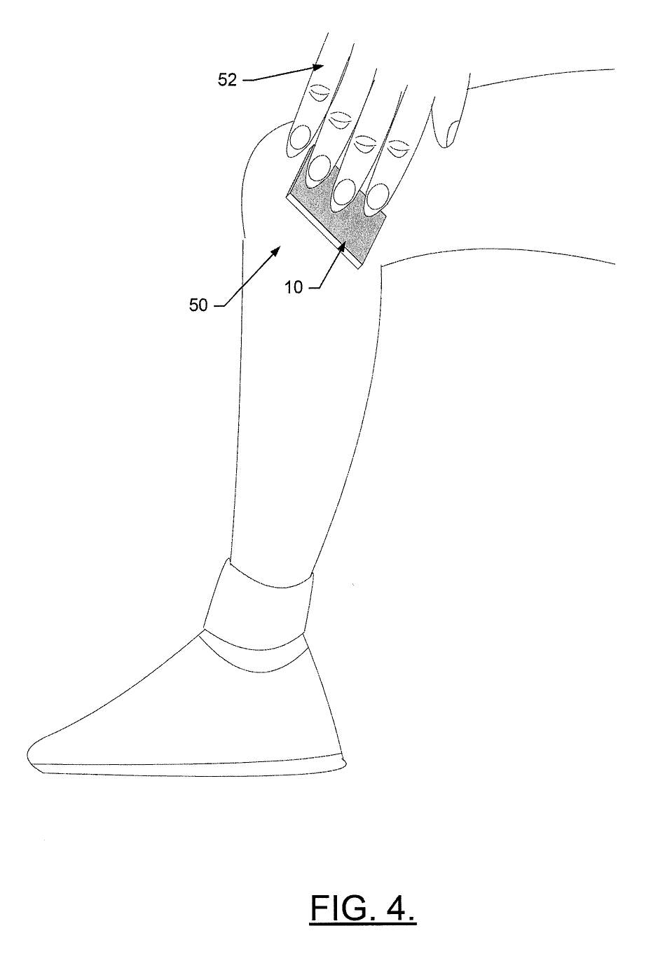

FIG. 4 is an illustration of an exemplary device capable of reproducing an animal vocalization for the treatment of a human knee 50 according to an exemplary embodiment of the present invention. As shown in FIG. 4, the device 10 may be held in contact with the knee 50 for a temporary period of time by, for example, a hand 52. However, as discussed above, numerous other mechanisms may be employed for securing the device 10 to any of numerous possible treatment areas, either on an animal or a human.

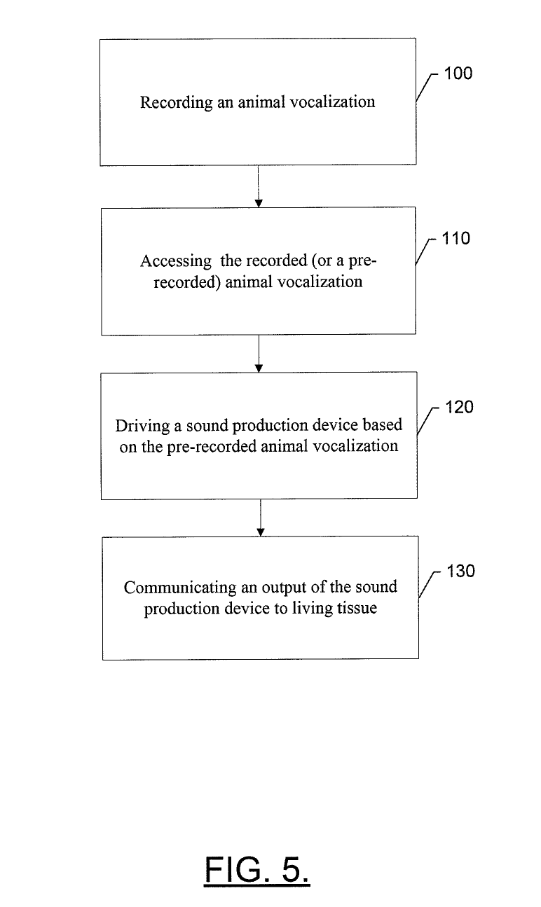

FIG. 5 is a flowchart of a method according to exemplary embodiments of the invention. It will be understood that each block or step of the flowchart, and combinations of blocks in the flowchart, can be implemented by various means, such as hardware, firmware, and/or software including perhaps one or more computer program instructions. In the case of computer program instructions, the instructions, when executed, may cause the processing element 14 to perform the functions associated with the method described below in connection with FIG. 5.

In an exemplary embodiment, as illustrated in FIG. 5, a method for providing an animal vocalization driven massage device may include accessing a pre-recorded animal vocalization at operation 110. At operation 120, a sound production device may be driven based on the pre-recorded animal vocalization. The sound production device may be an actuator having a frequency response of at least about 25 Hz to about 120 Hz. An output of the sound production device may be communicated to living tissue at operation 130. The output may include sound at about 32 dB to about 65 dB on contact with the living tissue. In an exemplary embodiment, the method may include an initial operation 100 of recording an animal vocalization including, in some instances both audible and inaudible frequencies, which could be, for example, a felid purr.

In an exemplary embodiment, driving the sound production device may include driving the actuator while the actuator is in contact with a substrate. Additionally, communicating the output of the sound production device to living tissue may include placing the substrate in operational communication with the living tissue or in operational communication with an object capable of contact with the living tissue. Alternatively, the actuator may be placed in operational communication with the living tissue itself.

The above described functions may be carried out in many ways. For example, any suitable means for carrying out each of the functions described above may be employed to carry out embodiments of the invention. Additionally, many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for providing an animal vocalization driven massage device comprising:
accessing a pre-recorded animal vocalization;
driving a sound production device comprising an actuator in operational communication with a substrate based on the pre-recorded animal vocalization; and
communicating an output of the sound production device to living tissue.

2. A method according to claim 1, wherein communicating the output of the sound production device to living tissue comprises producing about 32 dB to about 65 dB on contact with the living tissue.

3. A method according to claim 1, further comprising an initial operation of recording an animal vocalization.

4. A method according to claim 3, wherein recording the animal vocalization comprises recording a felid purr.

5. A method according to claim 1, wherein driving the sound production device comprises driving the actuator having a frequency response of at least about 25 Hz to about 120 Hz.

6. A method according to claim 5, wherein communicating the output of the sound production device to living tissue comprises placing the substrate in operational communication with the living tissue or an object capable of contact with the living tissue.

7. A method according to claim 5, wherein the substrate comprises the living tissue such that communicating the output of the sound production device to living tissue comprises placing the actuator in operational communication with the living tissue.

8. An apparatus for providing an animal vocalization driven massage device comprising:
a memory device storing a pre-recorded animal vocalization;
a sound production device comprising an actuator in operational communication with a substrate and configured to enable communication of an output of the sound production device to living tissue; and
a processing element in communication with both the memory device and the sound production device, the processing element being configured to drive the sound production device based on the pre-recorded animal vocalization.

9. An apparatus according to claim 8, wherein the sound production device is configured to produce the output at about 32 dB to about 65 dB on contact with the living tissue.

10. An apparatus according to claim 8, wherein the memory device stores an animal vocalization comprising a felid purr.

11. An apparatus according to claim 8, wherein the actuator includes a frequency response of at least about 25 Hz to about 120 Hz.

12. An apparatus according to claim 11, wherein the substrate is placed in operational communication with either the living tissue or an object capable of contact with the living tissue.

13. An apparatus according to claim 11, wherein the actuator is placed in operational communication with either the living tissue or an object capable of contact with the living tissue such that the living tissue or the object capable of contact with the living tissue comprises the substrate.

14. An apparatus according to claim 11, further comprising an attachment strap configured for attaching the actuator to an object capable of communication with the living tissue or the living tissue.

15. An apparatus for providing an animal vocalization driven massage device comprising:
a memory device storing a pre-recorded animal vocalization;
a sound production device configured to enable communication of an output of the sound production device to living tissue at about 32 dB to about 65 dB on contact with the living tissue; and
a processing element in communication with both the memory device and the sound production device, the processing element being configured to drive the sound production device based on the pre-recorded animal vocalization.

16. An apparatus according to claim 15, wherein the memory device stores an animal vocalization comprising a felid purr.

17. An apparatus according to claim 8, wherein the actuator includes a frequency response of at least about 25 Hz to about 120 Hz.

18. An apparatus according to claim 11, wherein the substrate is placed in operational communication with either the living tissue or an object capable of contact with the living tissue.

19. An apparatus according to claim 11, wherein the actuator is placed in operational communication with either the living tissue or an object capable of contact with the living tissue such that the living tissue or the object capable of contact with the living tissue comprises the substrate.

20. An apparatus according to claim 11, further comprising a user interface configured to receive user instructions for mode selection with respect to operation of the processing element.
